(19) United States
(12) Patent Application Publication
(10) Pub. No.: US 2007/0288181 A1
(43) Pub. Date: Dec. 13, 2007

(54) Method for testing cooling fan and apparatus thereof

(75) Inventors: Cheng-Huei Kuo, Taoyuan Hsien (TW); Thitipon Padchasri, Taoyuan Hsien (TW); Jedsada Kamjanrat, Taoyuan Hsien (TW)

Correspondence Address: BIRCH STEWART KOLASCH & BIRCH, PO BOX 747, FALLS CHURCH, VA, 22040-0747, US

(73) Assignee: DELTA ELECTRONICS INC.

(21) Appl. No.: 11/790,244

(22) Filed: Apr. 24, 2007

(30) Foreign Application Priority Data
May 22, 2006 (TW) 95118122

(51) Int. Cl. G01M 7/02; G06F 19/00

(52) U.S. Cl. 702/56; 73/570; 73/571

(57) ABSTRACT

A method and an apparatus for testing a cooling fan are provided. The method includes steps of: providing the testing apparatus including the holder centrally formed with the accommodating space, the vibration absorber disposed around the holder, and the vibration sensor connected to the holder; placing the cooling fan in the accommodating space of the holder; driving the cooling fan to rotate; applying the vibration sensor to detect the vibration value generated from the rotating cooling fan; and applying the vibration absorber to reduce the reaction force generated from the holder vibrated by the rotating cooling fan.

### CROSS REFERENCE TO RELATED APPLICATIONS

The present application claims priority under U.S.C. § 119(a) on Patent Application No(s). 095118122 filed in Taiwan, Republic of China on May 22, 2006, the entire contents of which are hereby incorporated by reference.

### BACKGROUND OF THE INVENTION

1. Field of the Invention

The invention relates to a method and an apparatus for testing a cooling fan, and in particular to a method and an apparatus for testing vibrations of a cooling fan.

2. Description of the Related Art

With the rapid development of efficiency in electronic devices and skill of packing, integrated circuits are small and high density. A highly efficient cooling device must be installed to dissipate heat generated by the integrated circuits, so as to prevent components from burnout and to increase the life of the electronic devices.

Fans are popular applications for dissipating heat. Materials and manufacturing precision are major factors in determining the quality and efficiency of the fan. If the blades of the fan are not uniformly manufactured, the center-of-gravity position of the fan may be off the rotational axis of the impeller of the fan, thus producing unbalance, vibration and noise during fan rotation and hindering fan reliability. Thus, quality control is important in the manufacturing processes.

In general, vibration testing of the fan is performed manually. Operator skill and fatigue level, however, affect quality control. Thus, a method of eliminating manual testing to increase yield is desirable.

### BRIEF SUMMARY OF THE INVENTION

The invention provides a method for testing a cooling fan. The method includes steps of: providing a testing apparatus including a holder centrally formed with an accommodating space, an vibration absorber disposed around the holder, and a vibration sensor connected to the holder; placing the cooling fan in the accommodating space of the holder; driving the cooling fan to rotate; applying the vibration sensor to detect a vibration value generated from the rotating cooling fan; and applying the vibration absorber to reduce the reaction force generated from the holder vibrated by the rotating cooling fan.

The method for testing the cooling fan further has a step of providing the vibration analyzer electrically connected to the vibration sensor, to thus analyze the vibration value. The method for testing the cooling fan further has a step of providing a computer electrically connected to the vibration sensor and the vibration analyzer so as to numerate the analyzed vibration value, wherein the quality of the cooling fan is verified by judging the numerated analyzed vibration value.

The invention further provides a testing apparatus for testing a vibration value generated from a cooling fan. The testing apparatus includes a holder, a vibration absorber and a vibration sensor. The holder includes an accommodating space to receive the cooling fan. The vibration absorber disposed around the holder reduces a reaction force generated from the holder vibrated by the rotating cooling fan. The vibration sensor connected to the holder senses a vibration value generated from the rotating cooling fan. The testing apparatus further includes a vibration analyzer electrically connected to the vibration sensor for analyzing the vibration value. The testing apparatus further includes a computer electrically connected to the vibration sensor and the vibration analyzer to numerate the analyzed vibration value, wherein the cooling fan is verified by judging the numerated analyzed vibration value.

The vibration absorber can be made of silicon or a shock damping material. The testing apparatus further includes a coordinate system with at least three coordinate axes, wherein the vibration sensor includes at least three contact points to detect vibrating components located at the three coordinate axes. The testing apparatus has a base, a post disposed on the base, a U-shaped supporting portion pivoted to the holder, and a balancing plate disposed on the post and connected to the U-shaped supporting portion. Also, the cooling fan has a frame formed as rectangular, circular, elliptical or diamond shape, and the accommodating space of the holder corresponds to the frame of the cooling fan. The cooling fan is an axial fan.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a schematic perspective view of a testing apparatus for testing a cooling fan according to the embodiment of the invention.

FIG. 2 is a schematic sectional view of the testing apparatus in FIG. 1.

FIG. 3 is a schematic view of a vibration sensor in FIG. 1.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

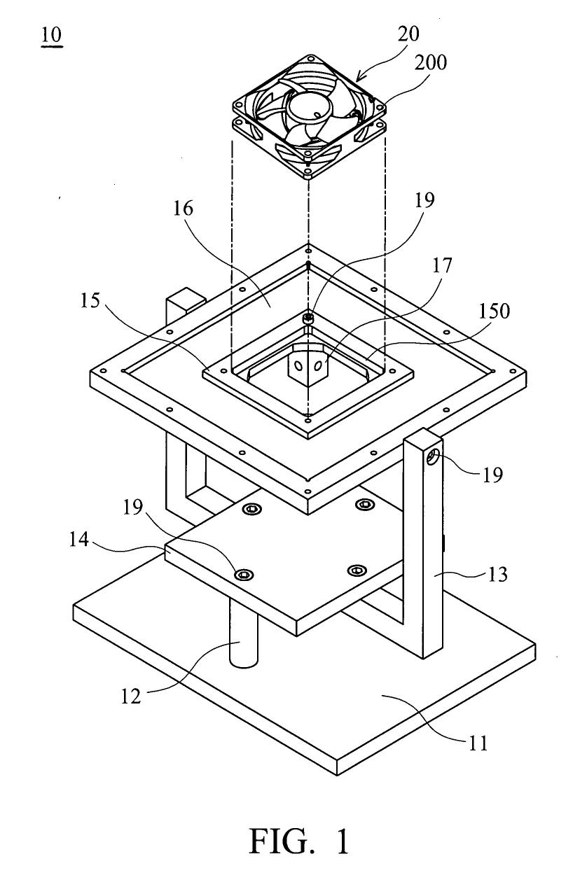

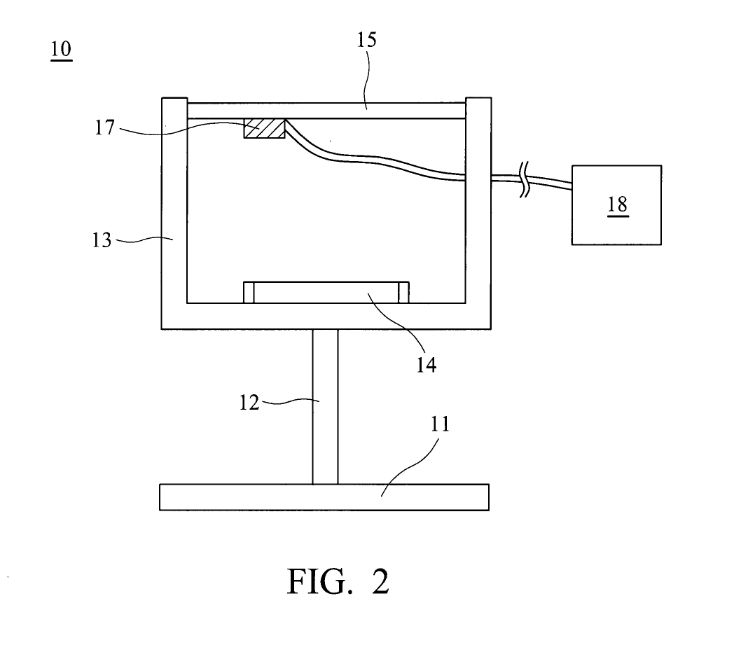

In FIGS. 1 and 2, a testing apparatus 10 for testing a cooling fan 20 having a frame 200 includes a base 11, a post 12 disposed on the base 11, a U-shaped supporting portion 13, a balancing plate 14 disposed on the post 12 and connected to the U-shaped supporting portion 13, a holder 15 pivoted to the U-shaped supporting portion 13 and centrally formed with an accommodating space 150 corresponding to the frame 200 of the cooling fan 20, a vibration absorber 16, a vibration sensor 17, and a vibration analyzer 18 electrically connected to the vibration sensor 17 for analyzing the vibration value. The balancing plate 14 is connected to the post 12 and the U-shaped supporting portion 13 by bolts 19 or other fixing elements.

The accommodating space 150 of the holder 15 receives the frame 200 of the cooling fan 20. The vibration absorber 16 disposed around the holder 15 reduces a reaction force generated from the holder 15 vibrated by the rotating cooling fan 20. The vibration sensor 17 connected to the holder 15 senses a vibration value generated from the rotating cooling fan 20.

The vibration absorber 16 is made of silicon or a shock damping material, to prevent output of vibration of the rotating cooling fan 20, thus, reducing interference caused by an external vibration, stabilizing the testing process, and obtaining an accurate testing value.

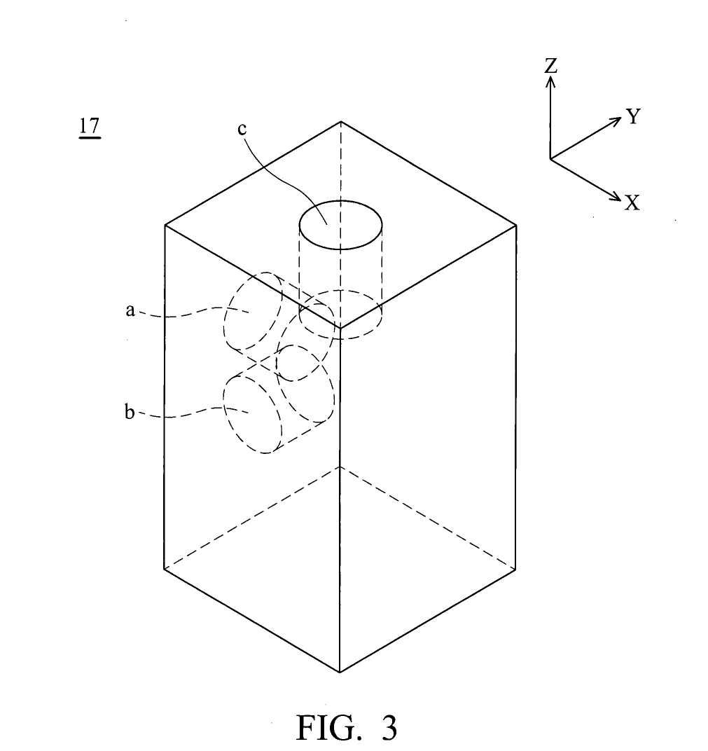

In FIG. 3, the testing apparatus 10 is configured under a coordinate system XYZ with three coordinate axes X, Y and Z. The vibration sensor 17 includes at least three contact points “a”, “b” and “c” to detect vibrating components located at the coordinate axes X, Y and Z. A computer (not shown in FIGS.) electrically connected to the vibration sensor 17 and the vibration analyzer 18 numerates the analyzed vibration value, wherein the cooling fan 20 is verified by judging the numerated analyzed vibration value. In this embodiment, the cooling fan 20 is an axial fan, and the frame 200 of the cooling fan 20 is formed as a rectangle, circle, ellipse or diamond shape.

The embodiment further provides a method for testing the cooling fan 20. The method of the embodiment includes steps of: providing the testing apparatus 10 including the holder 15 centrally formed with the accommodating space 150, the vibration absorber 16 disposed around the holder 15, and the vibration sensor 17 connected to the holder 15; placing the cooling fan 20 in the accommodating space 150 of the holder 15; driving the cooling fan 20 to rotate; applying the vibration sensor 17 to detect the vibration value generated from the rotating cooling fan 20; and applying the vibration absorber 16 to reduce the reaction force generated from the holder 15 vibrated by the rotating cooling fan 20. Further, the method for testing the cooling fan 20 includes a step of providing the vibration analyzer 18 electrically connected to the vibration sensor 17, to thus analyze the vibration value. More, the method for testing the cooling fan 20 includes a step of providing the computer electrically connected to the vibration sensor 17 and the vibration analyzer 18, to thus numerate the analyzed vibration value, wherein the cooling fan 20 is verified by judging the numerated analyzed vibration value.

Thus, the testing apparatus 10 and the method thereof for testing the cooling fan 20 of the embodiment apply a mechanical testing process to replace the traditional manual testing process to increase accuracy and precision of the testing result.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for testing a cooling fan, comprising steps of:
providing a testing apparatus comprising a holder centrally formed with an accommodating space, a vibration absorber disposed around the holder, and a vibration sensor connected to the holder;
placing the cooling fan in the accommodating space of the holder;
driving the cooling fan to rotate;
applying the vibration sensor to detect a vibration value generated from the rotating cooling fan; and
applying the vibration absorber to reduce a reaction force generated from the holder vibrated by the rotating cooling fan.

2. The method for testing the cooling fan as claimed in claim 1, further comprising a step of providing a vibration analyzer electrically connected to the vibration sensor for analyzing the vibration value.

3. The method for testing the cooling fan as claimed in claim 2, further comprising a step of providing a computer electrically connected to the vibration sensor and the vibration analyzer so as to numerate the analyzed vibration value, wherein the cooling fan is verified by judging the numerated analyzed vibration value.

4. The method for testing the cooling fan as claimed in claim 1, wherein the vibration absorber comprises silicon or a shock damping material.

5. The method for testing the cooling fan as claimed in claim 1, further comprising a step of providing a coordinate system with at least three coordinate axes, wherein the vibration sensor comprises at least three contact points to detect vibrating components located at the three coordinate axes.

6. The method for testing the cooling fan as claimed in claim 1, wherein the testing apparatus further comprises a base, a post disposed on the base, a U-shaped supporting portion pivoted to the holder, and a balancing plate disposed on the post and connected to the U-shaped supporting portion.

7. The method for testing the cooling fan as claimed in claim 1, wherein the cooling fan comprises a frame formed as a rectangular, circular, elliptical or diamond shape, and the accommodating space of the holder corresponds to the frame of the cooling fan.

8. The method for testing the cooling fan as claimed in claim 1, wherein the cooling fan is an axial fan.

9. A testing apparatus for testing a vibration value generated from a cooling fan, the testing apparatus comprising:
a holder comprising an accommodating space to receive the cooling fan;
a vibration absorber disposed around the holder to reduce a reaction force generated from the holder vibrated by the rotating cooling fan; and
a vibration sensor connected to the holder to detect a vibration value generated from the rotating cooling fan.

10. The testing apparatus as claimed in claim 9, further comprising a vibration analyzer electrically connected to the vibration sensor for analyzing the vibration value.

11. The testing apparatus as claimed in claim 10, further comprising a computer electrically connected to the vibration sensor and the vibration analyzer so as to numerate the analyzed vibration value, wherein the cooling fan is verified by judging the numerated analyzed vibration value.

12. The testing apparatus as claimed in claim 9, wherein the vibration absorber comprises silicon or a shock damping material.

13. The testing apparatus as claimed in claim 9, further comprising a coordinate system with at least three coordinate axes, wherein the vibration sensor comprises at least three contact points to detect vibrating components located at the three coordinate axes.

14. The testing apparatus as claimed in claim 9 further comprising a base, a post disposed on the base, a U-shaped supporting portion pivoted to the holder, and a balancing plate disposed on the post and connected to the U-shaped supporting portion.

15. The testing apparatus as claimed in claim 9, wherein the cooling fan comprises a frame formed as a rectangular, circular, elliptical or diamond shape, and the accommodating space of the holder corresponds to the frame of the cooling fan.

16. The testing apparatus as claimed in claim 9, wherein the cooling fan is an axial fan.
